(19) United States
(12) Patent Application Publication
(10) Pub. No.: US 2004/0176905 A1
(43) Pub. Date: Sep. 9, 2004

(54) Telematics script engine

(76) Inventors: Douglas Ray Sanqunetti, Cicero, IN (US); Jeffrey D. Johnson, Fairmount, IN (US); Rena Yamamoto, Berkeley, CA (US); Peter Thayer, Mountain View, CA (US)

Correspondence Address: Robert E. Krebs, THELEN REID & PRIEST LLP, P.O. Box 640640, San Jose, CA, 95164-0604, US

(21) Appl. No.: 10/379,807

(22) Filed: Mar. 6, 2003

(51) Int. Cl. G01C 21/26

(52) U.S. Cl. 701/200; 340/425.5

(57) ABSTRACT

A mobile device for a vehicle is disclosed, which uses scripts provided from a server. The scripts can include indications that indicate the appropriateness of input data. Additionally, the scripts can include conditional actions that only occur when certain input data values are recorded.

### FIELD OF THE INVENTION

The present invention relates to telematics systems, especially telematics systems that obtain trip information data from a user at a mobile device for a vehicle.

### BACKGROUND INFORMATION

Telematics systems are systems that deliver information, communications and entertainment to vehicles and mobile devices. One important telematics application concerns communication with truck fleets. When a truck loads cargo, it is useful to obtain information such as HAZMAT classification, trailer number, seal number, fuel level, etc. Telematics systems use a mobile device in a vehicle that allows the user to input such material. Typically, a macro or form is provided to the mobile device. The macro prompts the user to input data into fixed fields. The user has to scroll through each field in the macro in order to input the data to the user. Consider a fixed macro system in which a number of different purchase orders need to be input. In prior systems, a fixed number of the fields need to be selected by the macro designer. If there are four fields for purchase order inputs and the user only has one purchase order, the other three fields need to be scrolled through resulting in a time loss and additional data transfer cost. Alternately, if the user needs to input ten purchase orders and there are four fields for purchase order inputs, the user would have to describe the purchase orders in a comment field rather than being able to input in the purchase order field. A further limitation of current systems is their inability to differentiate between scripts requiring substantial data entry and scripts requiring only simple data entry. This differentiation is important for the safe operation of a vehicle such as a truck. Complex data entry requiring a keyboard is a safety hazard while a vehicle is in motion.

It is desired to have an improved telematics system to increases the flexibility of the mobile devices at a vehicle.

### SUMMARY OF THE PRESENT INVENTION

Exemplary embodiments of the present invention relate to a method. The method includes, at a mobile device for a vehicle, using a script to request input data concerning a trip. The script is used to determine a conditional action to occur when the script obtains a certain data value.

An exemplary embodiment of the present invention relates to a script for a mobile device for a vehicle. The script is adapted to cause the mobile device to request input data concerning a trip. The script includes an indication of a conditional action to occur when certain data values are input.

In an exemplary embodiment, the present invention relates to a mobile device for a vehicle. The mobile device uses a script to request input data concerning a trip. The script indicates a conditional action to occur when certain data values are input.

Exemplary embodiments of the present invention relate to a method. The method includes, at a mobile device for a vehicle, using a script to produce at least one prompt for a user to input data concerning a trip. The appropriateness of at least some of the input data is evaluated using indications in the script. When the user inputs a certain data value in response to one of the at least one prompts, the script is used to determine a conditional action to occur.

In an exemplary embodiment, the present invention relates to a mobile device for a vehicle. The mobile device uses information obtained from the vehicle communication bus, and/or the location of the vehicle as reported from the GPS, and/or the current time of day to produce at least one prompt to a user or conditional action. The conditional action could include one or more prompts to the user or the set of data that is transmitted to the host system.

In an exemplary embodiment, the present invention relates to a mobile device for a vehicle. The mobile device uses information contained in one script to invoke another script the user must complete. Conditional actions could include interactions between scripts.

In an exemplary embodiment, the present invention relates to a mobile device for a vehicle. The mobile device uses information obtained from one script to complete some or all of the information required in another script.

In an exemplary embodiment, the present invention relates to a mobile device for a vehicle. The mobile device uses information obtained from a script to enable or disable a vehicle operator from entering data into the script while the vehicle is in motion.

### BRIEF DESCRIPTION OF THE DRAWINGS

Other objects and advantages of the present invention will be apparent to one skilled in the art upon reading the following detailed description of the preferred embodiments, in conjunction with the accompanying drawings, wherein:

FIG. 1A is a flowchart that illustrates one embodiment of the system of the present invention.

FIG. 1B is a flowchart that illustrates one embodiment of the system of the present invention.

FIG. 2 is a diagram of a system of one embodiment of the present invention.

FIG. 3 is a flowchart of a portion of a script of one embodiment of the present invention.

FIG. 4 is a diagram of one embodiment of the system using scripts of one embodiment of the present invention.

FIG. 5 is a diagram of a user interface architecture of one embodiment of the system of the present invention.

FIGS. 6A-6L are diagrams that illustrate mobile device displays of one embodiment of the present invention.

FIGS. 7A-7D illustrate server screens of one embodiment of the present invention.

FIG. 8 illustrates a server screen of an embodiment of the present invention.

### DETAILED DESCRIPTION OF THE EXEMPLARY EMBODIMENTS

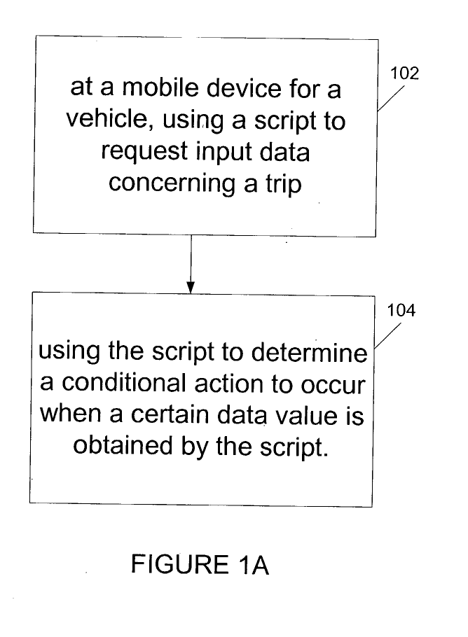

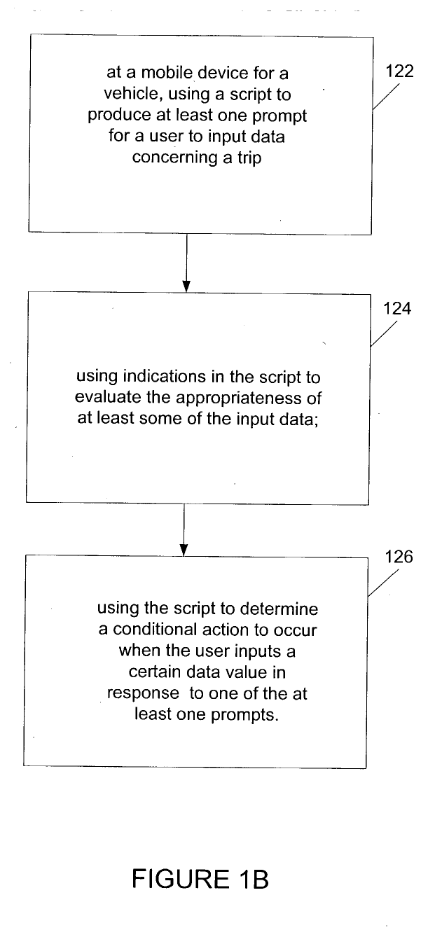

FIG. 1A is a flow chart that illustrates a method of the present invention. In Step 102, at a mobile device for a vehicle, a script is used to request input data concerning a trip. Input data can include driver responses, vehicle bus data, vehicle position data, discrete input (switch setting) data, analog input (voltage level) data, time data, or any other measurable or readable value obtainable by the mobile device.

The vehicle can be a car, truck, boat, plane or any other type of vehicle. The mobile device can be a computing device such as a portable computer. The portable computer can include a communications device such as a wireless unit that allows it to connect to a server. The script can be written in an interpreted language. The data concerning the trip can include any type of information related to the operation of a vehicle. For example, the trip data for a truck fleet data can include any information relating to the transfer of goods including HAZMAT classifications, trailer numbers, seal numbers, fuel levels and the like. The prompt can be a request for the user to input data. Such a prompt can include a visual display, an audio display, or any other type of display. Trip data could also include any measurable reading available to the mobile device such as vehicle communication bus data, discrete input data, analog input data, GPS position data, etc.

In step 104, the script is used to determine a conditional action to occur when a certain data value is obtained by the script. The conditional action can be a prompt that is displayed only if certain data values are entered or some other action that is only done if certain data values are entered or obtained programmatically by the device, or calculated based on previously entered or obtained values.

For the purpose of this application, the term “certain data values” means that not all the potential user inputs to the mobile device will cause the conditional action to occur. This limitation is distinguished from a system in which any input value will cause the next prompt to occur. The presentation of the next prompt in a fixed series of prompts cannot be considered to be a “conditional action” because the next prompt occurs no matter what data value is input.

In one embodiment, the request is a prompt to a user. In one embodiment, the request is made to an electronic device, such as a unit connected to a data bus, at the vehicle.

In one embodiment, indications in the script are used to evaluate the appropriateness of at least some of the input data. For example, one indication, for a yes/no question, ensures that the response is in the yes/no format. If the input has a natural range, the indications can indicate the natural range and prevent a user from inputting indications outside the natural range. For example, if a reasonable weight range is from 1000-2000 lbs., an indication can insure that the input data is within this range.

Scripts that allow conditional actions can be flexible in terms of user input. For example, the system can prompt the user to indicate whether additional purchase orders are to be input. If there are no more purchase orders to input, the user need not scroll past additional purchase order input prompts. Such a flexible system has advantages over the prior art systems that use a fixed number of purchase order input fields. The “conditional actions” can be in response to events that are unlikely to occur, such as a truck breakdown.

In one example, the script includes indications of when to transfer data from the mobile device. Such indications can be an indication to transmit the data from the mobile device to a server or to buffer data for a later transfer.

In one example, the script includes indications of what data to transfer from the mobile device. Such indications can be an indication to transmit certain data only if the proper set of conditions are met.

In one example, the script indicates visual display information for at least one prompt. This visual display information can be a screen display requesting that the user input data. Information for the screen display can be contained within the script.

In one example, input data is obtained from the vehicle communication bus for use in data transmission, script conditional logic, or user display. In one example, input data is obtained from the one or more measurable discrete inputs for use in data transmission, script conditional logic, or user display. In one example, input data is obtained from the measurable analog inputs for use in data transmission, script conditional logic, or user display. In one example, input data is obtained from the output of other scripts for use in data transmission, script conditional logic, or user display.

In one example, the execution of a script can be determined by logic expressed in a previous script. In one example, the script includes instructions on executing a different script if certain conditions are met. For example, a script concerning shipment delivery may invoke a script relating to damaged goods claims if there is indication in the delivery script of cargo damage.

In one example, the script acquires data that is useful to many scripts and can be shared between them. For example, a script concerning trailer pickup may acquire the new trailer number. This trailer number could be used in a script concerning load delivery or trailer drop off.

In one embodiment, the script is written in a trip information script language. A trip information script language is a language that allows for the efficient construction of scripts for querying using the mobile device.

In one example, the scripts are wirelessly transferred to the mobile device. The scripts can be transferred from a server that maintains the scripts. Using a server allows the fleet manager to modify the scripts.

The input data at the mobile device can be wirelessly transferred from the mobile device. In an example embodiment the input data is transferred to a server.

The conditional action can comprises an additional prompt for user input or measurement of any value available to the mobile device such as the vehicle bus or discrete inputs.

In one embodiment, the script can implement a function reviewing user comments for swear words. Such swear words can be deleted from the messages.

FIG. 1B is a flow chart that illustrates a method of the present invention. In Step 122, at a mobile device for a vehicle, a script is used to produce at least one prompt for a user or data transmission to a server based on input data concerning a trip. In step 124, indications in the script are used to evaluate the appropriateness of at least some of the input data. In step 126, the script is used to determine a conditional action to occur when the user inputs a certain data value in response to one of the prompts.

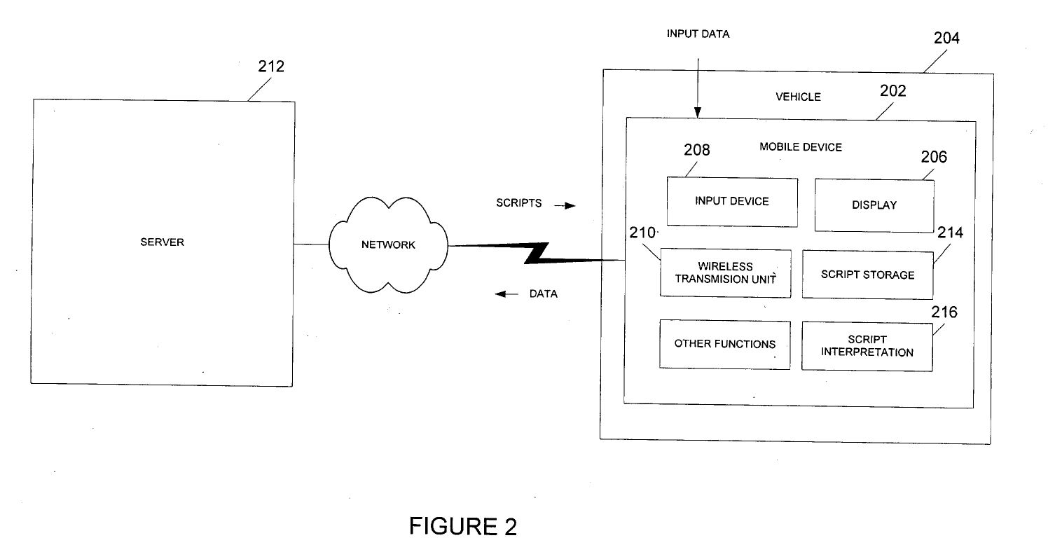

FIG. 2 illustrates one example of a system of one embodiment of the present invention. In this example, a mobile device 202 is located at a vehicle 204. The mobile device includes a display 206 such as a keyboard touch screen or a vocal speech recognition unit or any other type of input. A wireless transmission unit 210 can use, WiFi, cellular data networks, satellite networks and/or any other wireless communication system. In one embodiment, the mobile device 202 selects the cheapest available wireless network to transfer data. For example, a WiFi network will be used if available, otherwise a cellular data network will be used if available. If both of these wireless networks are unavailable, satellite transmission can be used for high priority scripts such as load acceptance, loader and shipper reports. Script interpretation function 216 interprets the script in order to produce a series of prompts to receive input data from the user.

In an exemplary embodiment, a mobile device uses the script to request input data concerning a trip. The script includes an indication of a conditional action to occur when certain data values are input.

In one embodiment, the request is a prompt to a user. In one embodiment, the request is from an electronic device at the vehicle. In one embodiment, the script includes indications to evaluate the appropriateness of at least some of the input data. In one embodiment, the script includes indications when to transfer input data from the mobile device. In one embodiment, the script indicates to the mobile device visual display information. In one embodiment, the conditional action comprises an additional prompt for user input or measurement of any value available to the mobile device such as the vehicle bus or discrete inputs. In one embodiment, the conditional action comprises an additional measurement from the vehicle communication bus. In one embodiment, the conditional action comprises an additional measurement of a discrete input. In one embodiment, the conditional action comprises an additional analog input. In one embodiment, the conditional action comprises an action causing another script to be invoked.

The script can cause the mobile device to produce at least one prompt for user to input data concerning a trip or the script data may cause (solely or in addition to) data to be obtained from the vehicle bus, from other script inputs, or from measurable inputs on the device, such as discrete or analog inputs. The script can include indications used by the mobile device to evaluate the appropriateness of at least some of the input data. The script can includes an indication of a conditional action to occur when the certain data values are input in response one of the at least one prompt or other form of data acquisition.

In one embodiment, the script is written using a script language, such as a trip information script language. A script language allows for different scripts be created for different functions that need not be hard-coded. Customized scripts can be developed for data collection from the mobile devices.

A trip information script language is a computer language designed to simplify querying using the mobile device. An example of a trip information script is the Trip Information Service Script Language (TISSL). The syntax of TISSL is given below in the in the Bacus Naur Form (BNF):

```
<int-literal>::= [0-9]+
<real-literal>::=[−]?(([0-9]+[.]?)|([0-9]*[.][0-9]+
<letter>::= [a-zA-Z]
<hex-literal>::=[$][0-9afA-F]{1,2}
<string-literal>::= \“[\hat{ }″]*\”
<EXPRESSION>::=[>,<,‘==’,‘<=’,>=‘,!=’]
<OPERAND>::=[+,−,*,/]
<CONNECTOR>::=[‘∥’,‘&&’]
<END>::=“END”
<WHILE>::=“WHILE”
<IF>::=“IF”
<boolean>::= <variable>CONNECTOR<variable>
<expression>::= <boolean>|<boolean>CONNECTOR<expression>|<variable>
<while-statement>::= WHILE (<expression>){<program-statements>}+END
<if-statement>::=IF(<expression>){<program-statements>}+END
<assign-statement>::= <variable> ‘=’ <variable> | <variable> ‘=’ OPERAND <variable> |
<variable> ‘=’ <get-statement> | <variable> ‘=’ ‘CURGPS’ ‘(‘ ’)’ | <variable> ‘=’
‘CURTIME’ ‘(‘ ’)’ | <variable> ‘=’ ‘CURDATE’ ‘(‘ ’)’ | <variable> ‘=’ ‘BUSDATA’ ‘(‘
<integer> ’,‘ <integer> ’,‘ <integer> ’,‘ <integer> ’)’ | <variable> ‘=’ ‘PARKEDIDLEFUEL’
‘(‘ ’)’ | <variable> ‘=’ ‘WALLETUSER’ ‘(‘ <integer> ’)’ | <variable> ‘=’
‘WALLETTRUCK’ ‘(‘ <integer> ’)’
<get-statement>::=‘GET LISTBOX’ ‘(‘<variable>, <variable>, <opt-default>’)’ | ‘GET
INTEGER’ ‘(‘ <variable>, <variable>, <variable>, <variable>, <opt-required>, <opt-
default>’)’ | ‘GET FLOAT ‘(‘ <variable>, <variable>, <variable>, <variable>, <opt-
required>, <opt-default>’)’ | ‘GET STRING ‘(‘ <variable>, <variable>, <opt-required>, <opt-
default>’)’ | ‘GET STRING MASK ‘(‘ <variable>, <variable>, <variable>, <opt-required>,
<opt-default>’)’, ‘GET DATE ‘(‘ <variable>, <opt-default>’)’, ‘GET TIME ‘(‘ <variable>,
<opt-default> ’)’, ‘GET CHECKBOX ‘(‘ <variable>, <variable>, <opt-required>, <opt-
default> ’)’,
<opt-default>::=|<variable>
<opt-required>::=|<variable>
<variable>::=[a-zA-Z_][a-zA-Z_0-9]*
<variable-list>::=<variable> | <variable> ‘=’ <real-literal> | <variable> ‘=’ <int-literal> |
<variable> ‘=’ <string-literal> | <variable> ‘,’ <variable-list>
<variable-def>::= STRING <variable-list> | INTEGER < variable-list > | FLOAT < variable-
list >
<print-def>::= ‘PRINT’ ‘(‘ <format-specifier> ’,‘ parameter-list ’)’ | ‘PRINT’ ‘(‘ <format-
specifier> ’)’
<log-def>::= ‘LOG’ ‘(‘ <format-specifier> ’,‘ parameter-list ’)’ | ‘LOG‘(‘ <format-specifier>
’)’
<format-specifier>::= ‘“’*<param_decl>*‘”’ | ‘“’*<param_decl>*‘”’ <format-specifier> |
‘“*”’
<param-decl>::= ‘%<length-spec>d’|‘%<length-spec>f’|‘%<length-spec>s’
<length-spec>::== <int-literal> | <int-literal> ‘.’ <int-literal>
<parameter-list>::= <variable> | <variable> ‘,’ <parameter-list>
An example of a script using the Trip Information Service Script Language (TISSL) to
implement a Load Acceptance macro is shown below:
/* Script for Loaded At Shipper */
INTEGER iProNo, iDropTrl;
STRING szHazMat, szDropTrl;
INTEGER iTrailerNo, iLicNo, iFuelLevel;
STRING szCompany, szOnTime, szDate, szTime, szNeedDir;
STRING szMorePOs;
INTEGER iPieces, iWeight;
STRING szBillLading, szPO, szComment;
PRINT(“Loaded At Shipper Macro v1.0\n”);
iProNo = GET INTEGER(“PRO #:”, 5, 0, 99999 ); /* 0-99999 Range valid
*/
szHazMat = GET STRING MASK(“HAZ MAT (Y/N)”, 1, “@”, “Y” );
PRINT(“\\PRO=%5d\\HAZ_MAT=%1s”, iProNo, szHazMat );
szDropTrl = GET STRING MASK(“DROP TRAILER (Y/N)”, 1, “@”, “Y”); /*
Yes/No Prompt */
IF ( szDropTrl == “Y” )
  iDropTrl = GET INTEGER(“DROP TRL #:”, 5, 0, 99999 );
  PRINT(“\\DROP_TRL=%5d”, iDropTrl );
END /* IF */
iTrailerNo = GET INTEGER(“CURRENT TRL #:”, 6, 999999, 0 ); /* Trailer No
between 0-999999 */
iLicNo = GET INTEGER(“CURRENT LIC #:”, 5, 99999, 0 ); /* Lic No between 0-
99999 */
szCompany = GET LISTBOX(“COMPANY:”, “COMPANY.LST” ); /* Get
company name from list box*/
szOnTime = GET STRING MASK(“I CAN DELIVER ON TIME (Y/N)”, 1, “@”, “Y”
); /* Yes/No Prompt */
PRINT(“\\TRL_NO=%5d\\LIC_NO=%5d\\COMPANY=%20s\\ON_TIME=%1s”,
iTrailerNo, iLicNo, szCompany, szOnTime );
szDate = GET DATE(“ETA (Date):” ); /* Using NULL default sets to current date */
szTime = GET TIME(“ETA (Time):” ); /* Using NULL default sets to current time */
szNeedDir = GET STRING MASK(“I NEED DIR TO NXT STOP”, 1, “@”, “Y” ); /*
Yes/No Prompt */
iFuelLevel = GET CHECKBOX(“REMAINING FUEL LEVEL:”,
“1/8,1/4,3/8,1/2,5/8,3/4,FULL”, 4 );
PRINT(“\\ETA=%10s %5s\\DIRECTIONS=%1s\\FUEL_LEVEL=%1”, szDate,
szTime, szNeedDir, iFuelLevel );
szMorePOs = GET STRING MASK(“DO YOU HAVE PO'S? (Y/N)”, 1, “@”, “Y”); /*
Yes/No Prompt */
WHILE (szMorePOs == “Y” )
  iPieces = GET INTEGER(“# OF PIECES:”, 5, 99999, 0 );
  iWeight = GET INTEGER(“WEIGHT:”, 6, 999999, 0 );
  szBillLading = GET STRING(“ENTER BILL OF LADING”, 10 );
  szPO = GET STRING(“ENTER PO”, 10 );
  PRINT(“\\PO=%10s\\BILL_LADING=%10s\\PIECES=%5d\\WEIGHT=%6d”,
szPO, szBillLading, iPieces, iWeight );
  szMorePOs = GET STRING MASK(“DO YOU HAVE MORE PO'S? (Y/N)”, 1, “@”,
“Y” ); /* Yes/No Prompt*/
END
szComment = GET LISTBOX(“COMMENT:”, “LOADED_COMMENT.LST” );
IF (szComment != “” )
  PRINT( “\\COMMENT=%20s”, szComment );
END
```

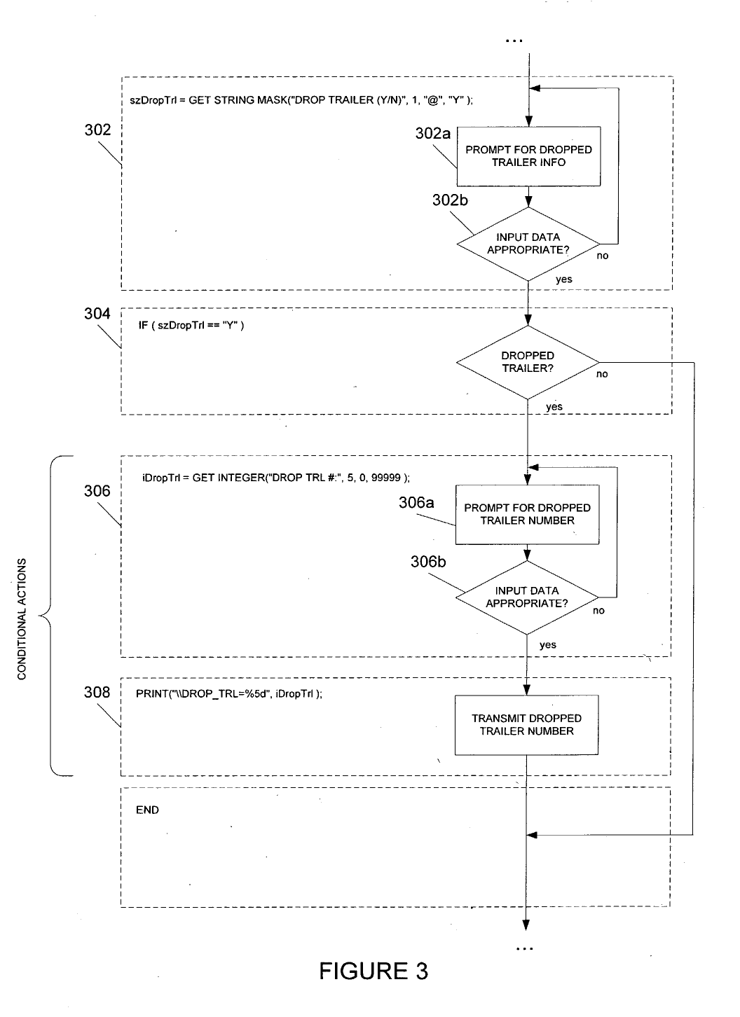

FIG. 3 is a flowchart that illustrates one example of the operation of the example script. In this example, instruction 302 includes a “Get String Mask” function. The function “Get String Mask” corresponds to a prompt screen for the user. The string “drop trailer (Y/N)” is an indication that can be displayed by the mobile device. The character “1” indicates response is received and is expected to be one digit long. The “1” character indicates that the input data is expected to be a yes or no response. The “Y” character indicates that the default response is yes. In one embodiment, the system parses the instruction into two sub-steps: producing the request, in this case a prompt to the user, in sub-step 302a, and checking the input data for correctness, in sub-step 302b. If the user does not input a yes or no response, the input data is indicated as being inappropriate and the prompt re-provided to the user. The input data is set equal to the variable szDropTII.

Instruction 304 is a check to see whether the input data indicates that the trailer was dropped. If the trailer was dropped, then the conditional actions of instructions 306 and 308 occur. Otherwise these conditional actions will not occur. In the instruction 306, the function is “Get Integer”, the displayed string is “Dropped TRL# ” and the input data is restricted to be a 5 letter entry within the range 0 to 99999. Sub-step 306a prompts the user for the dropped trailer number. Sub-step 306b checks whether the input data is within the range indicated in the script. In step 308, the drop trailer number is buffered to be transmitted. The Print function can result in the instant transfer of information or the adding of the information to a queue for transmission. Note that if there is not a dropped trailer, the conditional actions 306 and 308 are not done.

The use of a script allows for the flexibility in that the appropriateness of input data can be checked for as well as conditional actions can occur only upon certain input values.

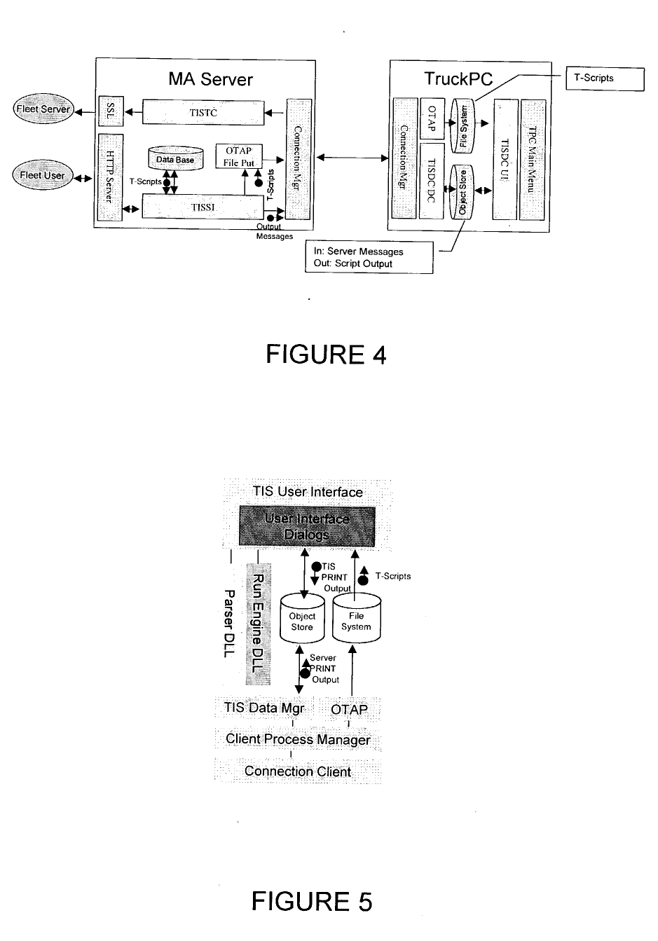

FIG. 4 illustrates an example of a system of one embodiment. In this embodiment, the mobile device is a TruckPC™ device. The TruckPC™ device is capable of running scripts. The TruckPC™ is also capable of displaying text messages from the device sent to the mobile device from the server. A TruckPC™ information data handler can be used to store messages sent from the server to the device. A TruckPC™ also can acquire data from the vehicle communication bus. A TruckPC™ can also monitor a set of discrete input lines and analog input lines.

In one embodiment, messages will be overwritten in the device in the first in first out basis. At the server, a trip information server interface (TISSI) allows an authenticated user to design, develop and test a script. The trip information server interface allows the user to maintain a set of scripts on a set of trucks. Additionally the trip information server interface allows the user to maintain a set of templates for presenting the operative messages for data entry.

In one embodiment, the scripts destined to go to the truck (Outbound scripts) were presented to the user as HTML templates. The extracted data from the output of the templates is sent to the truck for display in the mobile device. The transcoder interface (TISTC) breaks the data being sent up from the script running on the truck (Inbound scripts) and converts the data into a suitable format for the customer.

In one embodiment, a TruckPC™ device module (TISDM) is responsible for main menu selection on the mobile device. The TruckPC™ device module can be composed of two WinCE components. One component is a data component that interfaces with the connection manager. The data component is responsible for receiving and sorting output text messages from the server to the objects. The data component receives completed script outputs from the object store and transmits it to the server when the script execution is complete. The second component is the user interface application. This application is executable from the main menu. The application's responsibility is to present the user with a script selection screen and execute the script. The script output, such as in a Print command, can be stored in the object store. When the script is completed, the data in the object store can be transferred to the connection manager. The connection manager can maintain the connection between the mobile device and the server. The user interface at the mobile device allows the user to output messages sent from the server. The output messages can be text information messages. The scripts can be downloaded to the device at the server for using a Put File application—an application the provides “over the air programming” functionality.

At the server, the trip information server interface provides a graphical user interface for editing and testing scripts. In one embodiment, an existing script can be pasted along the screen, or a script can be retrieved from the stored display for display and editing. Editing can be done using a simple text editing capability or alternately an intelligent graphical user interface can be provided for composing proper text syntax to be used further. The trip information server interface can also provide a mechanism for maintaining the script for outbound messages. The fleet user can add edit or delete scripts assigned to them. The scripts can be selected in conjunction with one or more devices and rendered. The server can also include a trip information transcoder that provides means for tracking data uplinks from the mobile device and translating this information in suitable format for delivery to a customer system. Print statements within the script can indicate the format of the transmitted data. Additional formatting or encoding can be also used. In one embodiment, the server can interface with fleet servers and fleet users.

The script files can be text files that are rendered into a binary link list of executable statements using a program such as LEX and YACC or another compiler generating tool. A user defined set of variables can be implemented within the script parsing engine at the mobile device. The materials can be stored in a binary tree for simple fast access. Each parsed script can execute and use its own local heap handle. When the script terminates, the memory can be freed and the heap released. This script need not complete in a single user interface event. The user can partially complete a script, exit the application and perform other functions. The user can also handle multiple scripts at any time. A trip information server interface (TISSI) can provide a web-based mechanism for fleet personnel to create tasks and assign scripts to the vehicle. The transcoder can be fleet specific. The transcoder takes the data from the mobile device after it has arrived at the server and transmits the data to the fleet computer system. In one embodiment, the transcoder can produce an XML output stream.

FIG. 5 illustrates a trip information service user interface architecture of one embodiment of the present invention. In this example, the architecture has a number of components that can be assigned respective competencies. Reuse of the script parser or script engine is not a primary concern other applications may not need such functionality. In one embodiment, these elements are separated into separate data link libraries (DLLs) so that they can be separately developed then integrated.

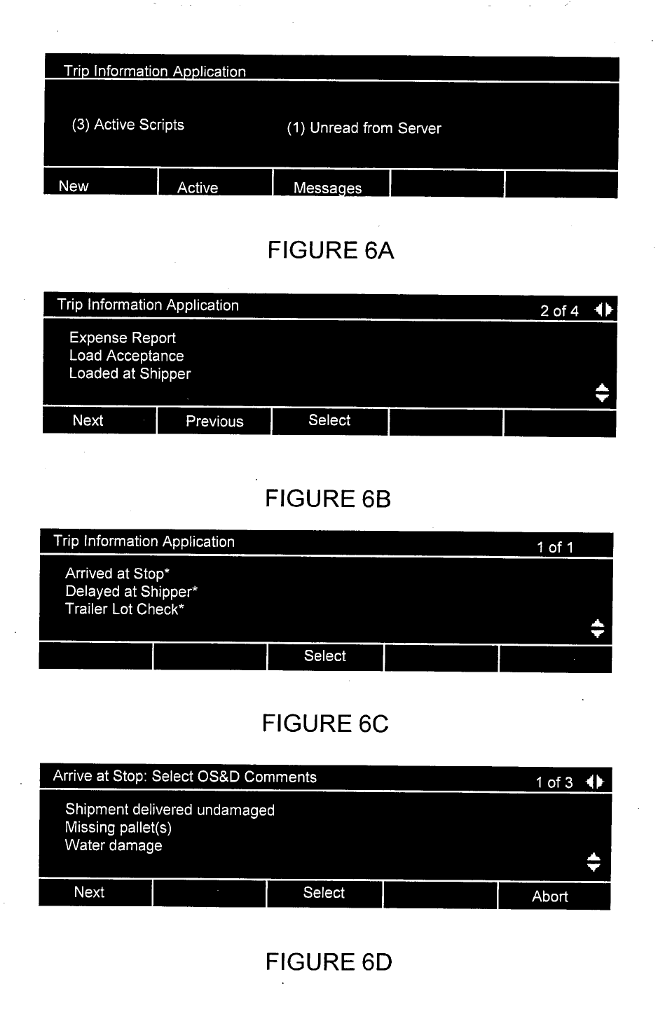

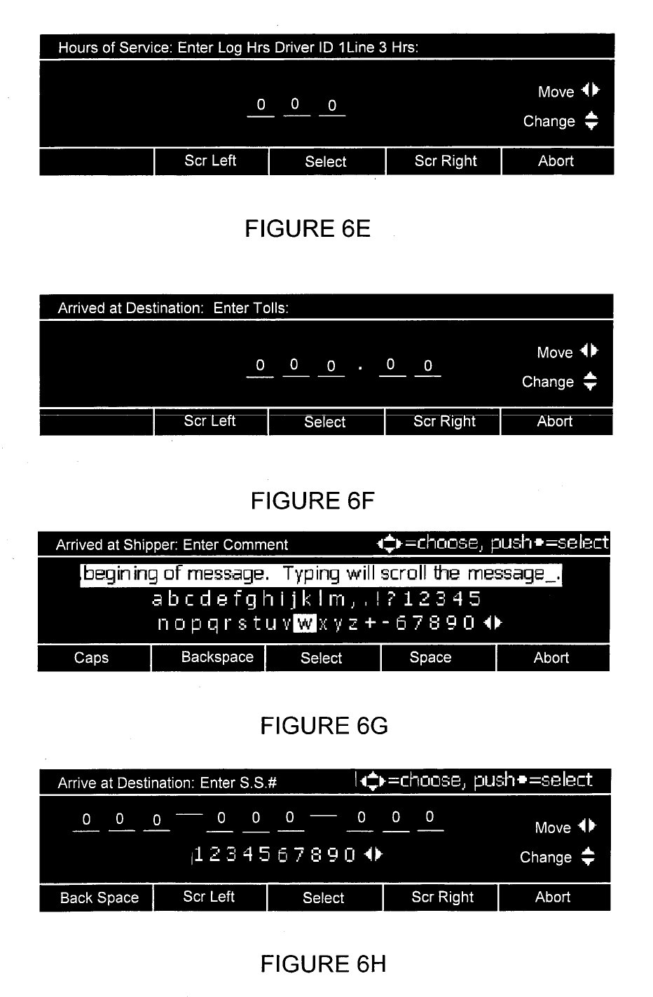

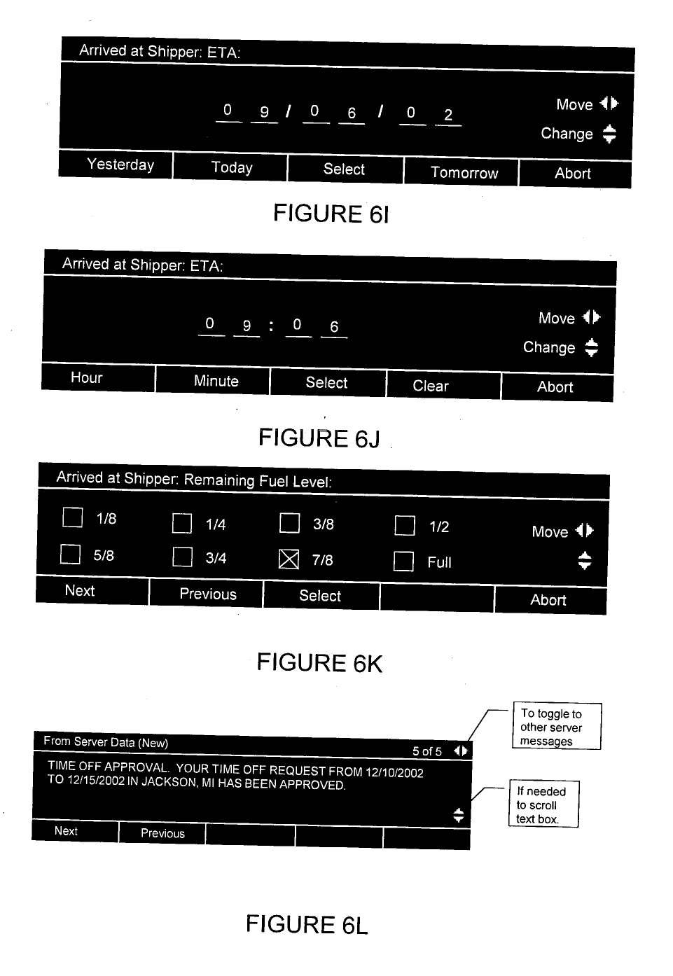

An example of a user interface for the mobile device is described below. An initial screen is displayed allowing a user to select <New Script> or <Active Script> if any active scripts are running. Additionally, the user can select <Messages> to view messages from the server. The number of new (unread) messages can be displayed. FIG. 6A illustrates a first screen from the main menu. The total number of active scripts running can be displayed.

If the user selects <New>, the new script selection screen is displayed. The values of the selection items in this list can be based on the file names located in the script storage of the mobile device. In one embodiment, the Script files have a common file designator, *.SCR. The SCR designator can be stripped before presenting the name in the list box. FIG. 6B depicts the new macro file selection box.

A further enhancement is to designate some scripts as safe to operate while driving. Scripts that can be completed successfully with only simple voice responses are safe to execute while driving. Scripts that require sophisticated keyboard typing can be allowed to execute only when the vehicle is parked.

If a script is active, it can be removed from the new script selection box so that a user will not run two identical scripts at the same time. A user can scroll through the items displayed in the screen using the up and down arrow keys. If more data is available than can fit on the screen, a “Next” soft key selection can be displayed. “Next” is available (and displayed) if a user can page down in the list. “Previous” is available and displayed if the user can page up in the list. The left and right arrow keys can also perform the same “page up” and “page down” scrolling function.

In one embodiment, a macro can be selected through either a soft key mapping “Select” or by using the “Enter” key. The position of the “Select” key can remain constant on the screen even if Next or Previous commands are not available. The left right scroll keys act as a page up/page down command. The up down scroll keys can act to scroll the cursor through the currently displayed items on the page. The font size can be set to display three or more selections on the list. The “Back” key can return the user to the Active/New selection screen if any active scripts are running, or to the main menu if no active scripts are running.

For active scripts, similar list display and selection can be implemented. FIG. 6C is an illustration of the first page of an active list selection screen. In this example, only three active scripts are running, so no page up/page down features are available. Active scripts can be presented in the same fashion as new scripts. In one example, an appended asterisk indicates that the scripts are active.

In one embodiment, a script runs as soon as it is selected. Active scripts can be returned to the last execution node. New scripts can be parsed with the parser and the first node loaded into the run engine. The run engine can handle output to the object store based on formatting and selection logic specified in the script. Table 1 outlines the dialog boxes the TISUI supports in one embodiment.

TABLE 1
TISUI Dialog Box Types

| Function Name | Type | Parameters |
|---|---|---|
| GetListBoxData | ListBox | &szPrompt: The display prompt for |
| | | input. |
| | | &szListFile: The data file name to load |
| | | into the list. |
| | | uiDefault: The default selection item. |
| | | uiOutLen: The length of *pszValue |
| | | storage. |
| | | pszValue: Pointer to the output storage |
| | | location. |
| GetInteger | Int Field | &szPrompt: The display prompt for |
| | | input. |
| | | iMaxValue: The maximum input value. |
| | | iMinValue: The minimum input value (0 |
| | | or neg). |
| | | iDefaultValue: The default input value. |
| | | piValue: The result storage location. |
| GetReal | Two | &szPrompt: The display prompt for |
| | integer | input. |
| | fields with | dMaxValue: The maximum input value. |
| | fixed 2 | dMinValue: The minimum input value (0 |
| | decimal | or neg). |
| | point. | dDefaultValue: The default input value. |
| | | pdValue: The result storage location. |
| GetString | Character | &szPrompt: The display prompt for |
| | input | input. |
| | | &szDefaultValue: The default input |
| | | value. |
| | | uiOutLen: The length of * pszValue |
| | | storage. |
| | | pszValue: The result storage location. |
| GetStringMask | Masked | &szPrompt: The display prompt for |
| | Char | input. |
| | Input | &szDefaultValue: The default input |
| | | value. |
| | | &szInputMask: A mask of input values |
| | | uiOutLen: The length of * pszValue |
| | | storage. |
| | | pszValue: The result storage location. |
| GetDate | Character | &szPrompt: The display prompt for |
| | for | input. |
| | Date | &szDefaultValue: The default input |
| | Data | value. |
| | | pszValue: The result storage location. |
| GetTime | Character | &szPrompt: The display prompt for |
| | for | input. |
| | Time | &szDefaultValue: The default input |
| | Data | value. |
| | | pszValue: The result storage location. |
| GetCheckBox | CheckBox | &szPrompt: The display prompt for |
| | Data | input. |
| | | &uiDefaultValue: The default checkbox |
| | | index. |
| | | &szCheckLables: A comma delimited |
| | | list of checkbox labels. Index 0 is first |
| | | entry. |
| | | puiValue: The index of the selected |
| | | checkbox. |

There is an additional output function for outputting data to the server. This output function receives a string that it should append with the appropriate application header and place into the output queue. Table 2 provides the function format.

TABLE 2
TISUI Dialog Box Types

| | | |
|---|---|---|
| PrintOutput | Outputs macro | szOutput: The text to store in the output |
| | data to the | queue. |
| | ASYNC queue. | |
| | Pre-pends TI | |
| | application | |
| | header. | |

Keyboard input can be accepted at each input screen if a keyboard is available. Additionally, voice recognition input for discrete values (such as integers) and menu functions can also be used. For a long list of discrete inputs such as character data, enabling voice recognition is desirable if the performance is good. For example, saying “A” should select an “A” character.

FIG. 6D outlines the GetListBox entry function. The “Menu” key can return the user to the main menu. The “Back Key” can “freeze” the script, and return control to the script selection box. The “Abort” soft key aborts the script without saving any information and returns control to the script selection box.

FIG. 5E outlines the GetInteger entry function of one embodiment. The “Menu” key returns the user to the main menu. The “Back Key” can “freeze” the script, and return control to the script selection box. The “Abort” soft key aborts the script without saving any information and returns control to the script selection box. The left and right scroll keys moves the cursor to the different “ten's” position. The up and down cursor can rotate the numbers from 0-9 in a circular manner with an up arrow at 9 rolling into a zero. For the most significant input position, the circular list includes both the digits 0-9 and the sign key (-). The starting field can be the most significant digit position based on iMaxValue. For example, if iMaxValue is 100, the input cursor can be in the 3^{rd} (from right) column. Input can be allowed to go to the iMinValue field position. For example, if the iMinValue is 10, and iMaxValue is 100, only the 3^{rd} from right and 2^{nd} from right input positions can be editable.

FIG. 1F outlines the GetReal entry function of one embodiment. The left and right scroll keys moves the cursor to the different “ten's” position. The up and down cursor can rotate the numbers from 0-9 in a circular manner with an up arrow at 9 rolling into a zero. In one embodiment, for the most significant input position, the circular list can include both the digits 0-9 and the sign key (−). The starting field can be the most significant digit position based on dMaxValue. Precision of only two decimal points is needed. Therefore, data entry and formatting can work like the GetInteger function, except that two “integer” fields can be used, with one field representing the1/100ths value.

FIG. 6G describes the GetString entry function of one embodiment. The left, right, up and down scroll keys moves the cursor over a different alphanumeric display. The selection button selects the character into the current input space. Cursor keys, and a backspace key are also included in the input character set. The “Select” soft key completes the data input. Here the functionality is different from other screen entries where the Enter and Select soft key provided the same functionality. Enter copies the currently selected character into the field position and advances the cursor (if not at the end of the field.)

Caps toggles the uppercase/lowercase input mode. Backspace deletes the character to the left of the current input cursor position and moves the cursor left if the current cursor is not in the leftmost position. Select completes the data entry and returns the value to the script engine. Space inserts a space character at the current cursor position and scrolls the cursor right. Abort terminates the script and returns to the script selection menu. The menu key can return to the main menu, storing the current operation node of the script and leaving it active.

FIG. 6H describes the GetStringMask entry function of one embodiment. The functionality is similar to the GetString function, except a mask can be applied to facilitate and format data entry. Table 3 describes the characters that can have mask meanings.

TABLE 3
GetStringMask Mask Characters

| Mask | |
|---|---|
| Character | Input Values |
| # | Any decimal character (0-9) |
| & | Any uppercase alpha character |
| ? | Any lowercase alpha character |
| * | Any alpha numeric character (upper |
| | case). |
| @ | Yes/No Prompt |
| | All other values are inserted directly |
| | into the input field with no edits |
| | allowed. |

For example, “###-##-####” would produce an input mask suitable for a social security number. “(###)###-####” produces a mask suitable for a phone number.

The GetDate function is an extent of the GetStringMask function. However, it is geared to provide accurate and simplified date recording. The maximum day field can be limited based on the user month selection (E.G. the maximum day entry in September can be limited to 30.)

FIG. 6I illustrates the GetDate function. If szDefault value is null, today's date can be used as the default. The “Yesterday” soft key inserts yesterday's date. “Today” and “Tomorrow” work in a similar manner. “Select” and Enter take the current selection for input.

The GetTime function is an extent of the GetStringMask function. It is geared to provide accurate and simplified time recording. Time is reported in 24 hour format. GetTime is illustrated in FIG. 6J. If szDefault value is null, the current time is used as the default. The “Hour” soft key increments the hour value by one, rolling over at 24. The “Minute” soft key increments the current minute by 5, rolling over at 60. The “Clear” soft key clears the current selection and sets the time to 12:00. “Select” and Enter take the current selection for input.

FIG. 6K shows an example of a GetCheckBox function. The GetCheckBox function presents a dynamic sequence of checkboxes to the user. Memory allocation may be needed in order to establish from one to eight checkbox windows. One software technique, to reduce the possibility of memory fragmentation, would be to pre-allocate eight Windows to use for checkboxes. The dwstyle parameter can probably be left at BS_CHECKBOX. Each checkbox form should be considered to be an exclusive set of responses. (E.G. Only one checked box is allowed.) When a user selects any check box on the form, the other checkboxes on the form can be cleared.

uiDefaultValue is the default checkbox selected on form display. This value must be between 0-7 (or the maximum number of checkbox labels in the szCheckLables string). Any out of range values should force the selection to 0.

szCheckLables is an input string of comma delimited checkbox labels. For example, “⅛, ¼, ⅜, ½, ⅝, ¾, ⅞, Full” form a set of eight check box labels.

In one embodiment, the Server “From Server” component displays (and reads via text to speech) any output scripts sent from the server. The application can store the last five output scripts. However, once a user has viewed a script, it should be marked as read in the Object Store. Read scripts do not show up in “Unread from server” count, but are available for review, until a new script deletes it in a first-in-first-out manner.

Output scripts are received in a data component connected to connection manager using the client process manager. The data component should be the same component used for transmitting output scripts. Fixed records and record sizes should be used.

When a user selects “From Server”, she can be presented with the most recently received output script. The user has the ability to scroll back to review prior scripts. Once a script is viewed, its record should be updated to no longer show in the “Unread from Server” count. FIG. 6L illustrates the basic functionality of the “From Server” Screen of one embodiment.

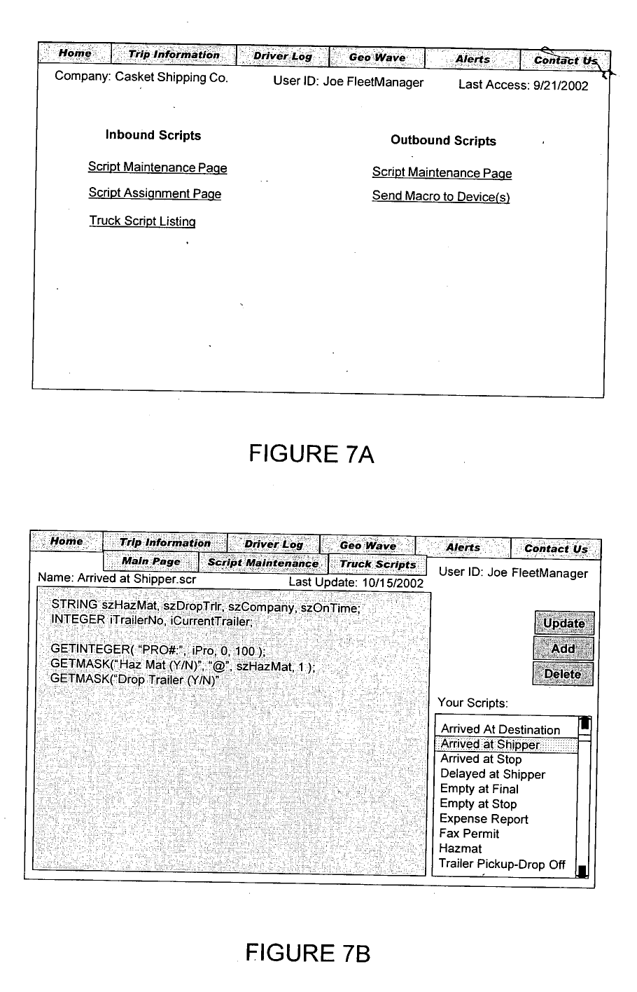

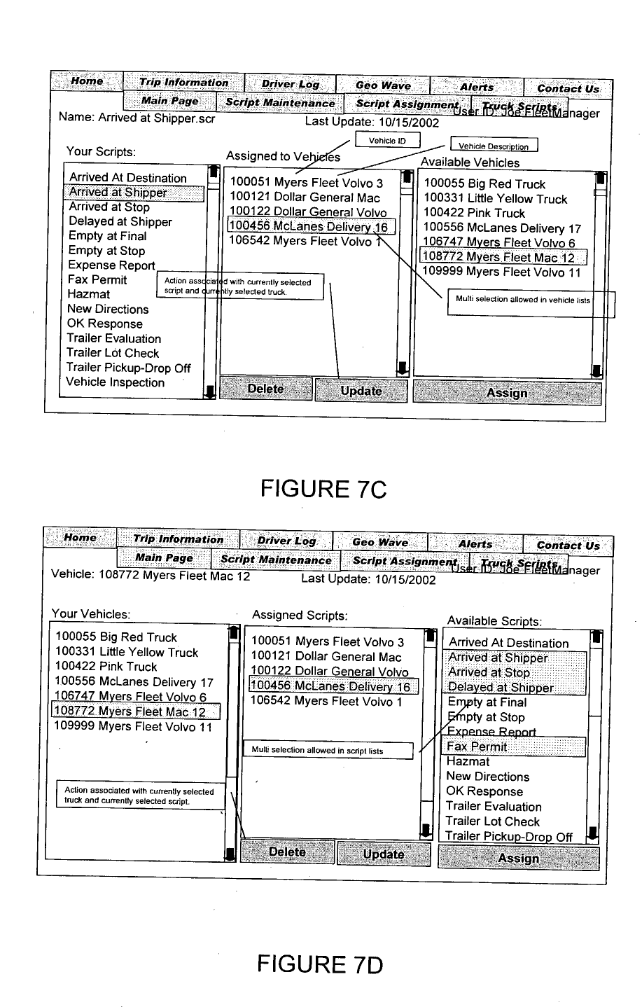

FIGS. 7A-7D illustrates screens that can be used at the server for manipulating the scripts. FIG. 7A illustrates a main script maintenance screen. The server script maintenance screen allows scripts to be retrieved, viewed, edited and saved. FIG. 7B illustrates a main script maintenance screen. Note that a script can be loaded on to the screen from a pre-existing script for editing or creation. FIG. 7C illustrates a script assignment screen which assigns the scripts to different vehicles within the fleet. FIG. 7D illustrates an inbound truck script listing page which lists all the scripts assigned to a particular vehicle based upon vehicle ID. Scripts can be added, updated, deleted from the vehicle from this page.

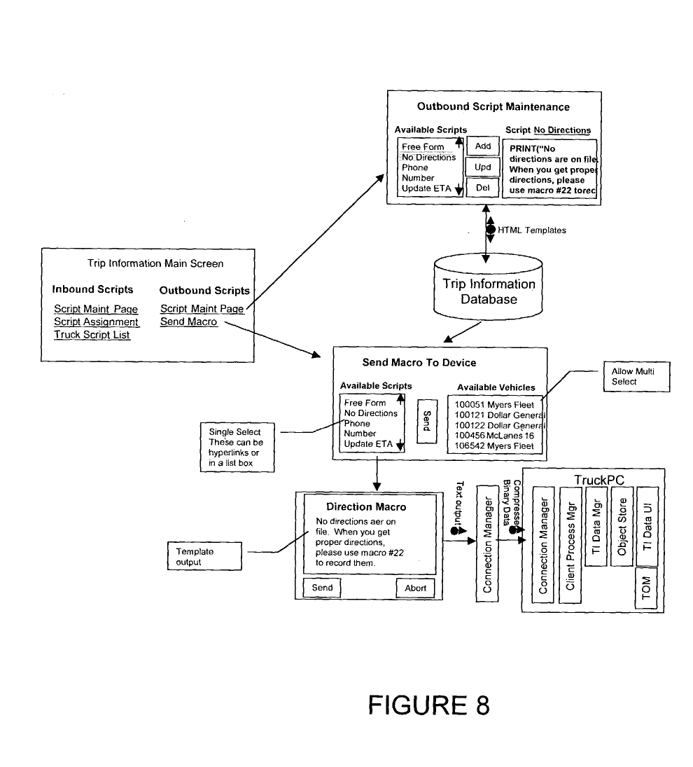

FIG. 8 is a diagram that illustrates the flow information for outbound scripts and script maintenance. Scripts are added and maintained in an outbound script maintenance page. This page allows the user to select the current script, edit it, or add a new script by pasting the script text into the edit window, and giving the script a name. A single script can be selected and sent to one or more devices simultaneously, using the outbound send macro page. The usual available scripts are provided as a set of list box entries. There is an associated list box in vehicles that support multiple selections. When the send button is invoked, the script is run in the frame within the viewer's browser. The output of the script print command is stored in a temporary buffer. When the script completes, the send button is enabled. Send allows the data in a temporary buffer to be queued into the connection manager.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

1. A method comprising:
at a mobile device for a vehicle, using a script to request input data concerning a trip; and
using the script to determine a conditional action to occur when a certain data value is obtained by the script.

2. The method of claim 1 wherein the request is a prompt to a user.

3. The method of claim 1 wherein the request is to an electronic device at the vehicle.

4. The method of claim 1, further comprising using indications in the script to evaluate the appropriateness of at least some of the input data.

5. The method of claim 1, wherein the script includes indications when to transfer input data from the mobile device.

6. The method of claim 1, wherein the script indicates to the mobile device visual display information.

7. The method of claim 1, wherein the script is written in a trip information script language.

8. The method of claim 1, wherein the input data is obtained from the vehicle communication bus for use in data transmission, script conditional logic, or user display.

9. The method of claim 1, wherein the input data is obtained from the one or more measurable discrete inputs for use in data transmission, script conditional logic, or user display.

10. The method of claim 1, wherein the input data is obtained from the measurable analog inputs for use in data transmission, script conditional logic, or user display.

11. The method of claim 1, wherein the input data is obtained from the output of other scripts for use in data transmission, script conditional logic, or user display.

12. The method of claim 1, wherein the execution of a script can be determined by the logic expressed in a previous script

13. The method of claim 1, further comprising wirelessly transferring the script to the mobile device.

14. The method of claim 1, further comprising wirelessly transferring input data from the mobile device.

15. The method of claim 1, wherein the conditional action comprises an additional prompt for user input or measurement of any value available to the mobile device such as the vehicle bus or discrete inputs.

16. A script for a mobile device for a vehicle, the script adapted to cause the mobile device to request input data concerning a trip, the script including an indication of a conditional action to occur when certain data values are input.

17. The script of claim 16 wherein the request is a prompt to a user.

18. The script of claim 16 wherein the request is from an electronic device at the vehicle.

19. The script of claim 16, wherein the script includes indications to evaluate the appropriateness of at least some of the input data.

20. The script of claim 16, wherein the script includes indications when to transfer input data from the mobile device.

21. The script of claim 16, wherein the script indicates to the mobile device visual display information.

22. The script of claim 16, wherein the script is written in a trip information script language.

23. The script of claim 16, wherein the conditional action comprises an additional prompt for user input or measurement of any value available to the mobile device such as the vehicle bus or discrete inputs.

24. The script of claim 16, wherein the conditional action comprises an additional measurement from the vehicle communication bus.

25. The script of claim 16, wherein the conditional action comprises an additional measurement of a discrete input.

26. The script of claim 16, wherein the conditional action comprises an additional analog input.

27. The script of claim 16, wherein the conditional action comprises an action causing another script to be invoked.

28. A mobile device for a vehicle, the mobile device using a script to request input data concerning a trip, the script includes an indication of a conditional action to occur when certain data values are input.

29. The mobile device of claim 28 wherein the requested is a prompt to a user.

30. The mobile device of claim 28 wherein the request is from an electronic device at the vehicle.

31. The mobile device of claim 28, wherein the script includes indications to evaluate the appropriateness of at least some of the input data.

32. The mobile device of claim 28, wherein the script includes indications when to transfer input data from the mobile device.

33. The mobile device of claim 28, wherein the script indicates to the mobile device visual display information.

34. The mobile device of claim 28, wherein the script is written in a trip information script language.

35. The mobile device of claim 28, wherein the conditional action comprises an additional prompt for user input or measurement of any value available to the mobile device such as the vehicle bus or discrete inputs.

36. The mobile device of claim 28, wherein the conditional action comprises an additional measurement from the vehicle communication bus.

37. The mobile device of claim 28, wherein the conditional action comprises an additional measurement of a discrete input.

38. The mobile device of claim 28, wherein the conditional action comprises an additional analog input.

39. The mobile device of claim 28, wherein the conditional action comprises an action causing another script to be invoked.

40. A method comprising:
at a mobile device for a vehicle, using a script to produce at least one prompt for a user to input data concerning a trip;
using indications in the script to evaluate the appropriateness of at least some of the input data; and
using the script to determine a conditional action to occur when the user inputs a certain data value in response to one of the at least one prompts.
